(19) United States
(12) Patent Application Publication
(10) Pub. No.: US 2010/0290641 A1
(43) Pub. Date: Nov. 18, 2010

(54) ENTRAINMENT RESISTANT FEEDBACK CANCELLATION

(76) Inventor: Brenton Robert Steele, Victoria (AU)

Correspondence Address: CHRISTIE, PARKER & HALE, LLP, PO BOX 7068, PASADENA, CA, 91109-7068, US

(21) Appl. No.: 12/746,913

(22) PCT Filed: Dec. 8, 2008
(86) PCT No.: PCT/AU2008/001807

§ 371 Date: Jun. 28, 2010

(30) Foreign Application Priority Data
Dec. 7, 2007 (AU) 2007906684

(51) Int. Cl. H04B 15/00

(52) U.S. Cl. 381/93

(57) ABSTRACT

This invention concerns a method, and a device, for feedback cancellation. This invention also concerns a computer program product comprising computer program code means to make a computer execute a procedure for feedback cancellation. The method comprises providing an adaptive feedback cancellation filter which adapts under the control of a control module, and filtering at least one input of the control module to suppress correlated signals from the input prior to the control module operating upon the input. The device comprises an adaptive feedback cancellation filter, a control module and at least one filter. The control module controls adaptation of the adaptive feedback cancellation filter. The filter suppresses correlated signals from an input to the control module prior to the control module operating upon the input.

### CROSS-REFERENCE TO RELATED APPLICATIONS

The present application claims priority from Australian Provisional Patent Application No 2007906684 filed on 7 Dec. 2007, the content of which is incorporated herein by reference.

### TECHNICAL FIELD

The present invention relates to sound processing devices in which an acoustic sound input is processed and converted to an acoustic sound output, and in particular relates to the cancellation of acoustic feedback in such a device when the sound input may include tonal and other periodic components.

### BACKGROUND OF THE INVENTION

Typical sound processing devices, such as hearing aids, comprise a microphone or other input transducer to pick up acoustic sounds and convert them into an electrical signal, an electronic processor and/or amplifier to increase the power of the electrical signal, and a speaker or other output transducer to convert the amplified electrical signal back into acoustic sound. If the input and output transducers are close enough, the output acoustic signal may be picked up by the input transducer and fed back into the amplifier with a delay, the delay being the time taken for the sound to travel from the output transducer to the input transducer, plus any delay due to the electrical processing of the signal. This is ‘acoustic feedback’. Electrical feedback can also occur if the electrical signal at the output is coupled back to the input, for example by inductive or capacitive coupling. Further, mechanical feedback can also occur if vibrations are transmitted from the output transducer to the input transducer via the body or case of the amplification system.

Under feedback conditions the loop gain is greater than 1, such that the feedback signal self-reinforces and increases in intensity to drive the components into saturation, reaching an equilibrium when the loop gain reduces to unity. At this equilibrium level the hearing aid device usually emits a continuous and unpleasant high pitched whistle or squeal. Further, oscillation and instability in the processing path are undesirable because they can distort the signal processing performance. This can lead to problems both for the hearing aid user and for those around.

One approach for increasing the stability of a hearing aid is to reduce the gain at high frequencies. In multi-band processing this may be done by setting a maximum gain value for each band which reduces with increasing frequency, or automatic high frequency (HF) gain roll-off may be used. However, this means that the desired high-frequency response of the instrument must be sacrificed in order to maintain stability, which is particularly undesirable given that human hearing loss often occurs to a greater extent in the higher audible frequencies than in the lower frequencies.

Efforts have also been undertaken to reduce the susceptibility of hearing aids to feedback oscillation by attenuation and notch filtering; estimation and subtraction of the feedback signal (feedback cancellation); and frequency shifting or delaying the signal.

A further difficulty in feedback cancellation arises where an input sound signal comprises tonal and other periodic signals which ideally should not be cancelled, such as music, beeps, dial tones and the like. Such tonal signals can be difficult for signal processing techniques to distinguish from oscillatory feedback which should be cancelled. For example, some feedback cancellation techniques assess an auto-correlation of an input signal, and attempt to filter out signals with a high correlation, oscillatory feedback being one such signal with high correlation. However, tonal signals of interest such as music also have a strong auto-correlation, with the result that feedback cancellation is inappropriately applied to the music signal in such techniques. This can result in a decreased efficacy of cancellation of actual feedback signals occurring simultaneously with the tonal input, and/or the production of audible artefacts such as ‘warbling’ when the tonal signal of interest is present. Such artefacts can also arise if adaptive feedback cancellation techniques cause a feedback estimation filter response to alter at a rate or by such an amount as to be perceptible to the user.

To provide a feedback estimation filter which responds appropriately to both tonal input signals and oscillatory feedback signals, respectively, some solutions utilise training to set a fixed filter response. However, such filter training necessitates an extra step in hearing aid fitting or implementation. Further, such fixed filters tend to have a limited range of situations in which feedback cancellation is adequately provided.

Other solutions utilise complicated tone detectors to detect situations where signals are present which include tones which could cause artefacts, for example by corrupting the filter taps. However, not all tones lead to corruption of filter taps, and such systems can thus detect a tone and reach a false positive determination that a filter has been corrupted, even when the filter has not been corrupted or has not been unacceptably corrupted. Conversely, tonal signals which may not be detected by a tone detector can nevertheless cause filter corruption, leading to a false negative determination. Some systems use a tone detector in order to control the adaptation rate of the feedback cancellation filter. By slowing the adaptation rate of the filter the presence of a tonal signal is less likely to corrupt the filter and give rise to artefacts. However a slowly adapting filter is susceptible to producing short bursts of feedback squeal if the feedback path changes faster than the FBC's adaptation rate.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method for feedback cancellation, the method comprising:
providing an adaptive feedback cancellation filter which adapts under the control of a control module; and
filtering at least one input of the control module to suppress correlated signals from the input prior to the control module operating upon the input.

According to a second aspect the present invention provides a device for feedback cancellation, the device comprising:
an adaptive feedback cancellation filter;
a control module which controls adaptation of the adaptive feedback cancellation filter; and
at least one filter for suppressing correlated signals from an input to the control module prior to the control module operating upon the input.

A computer program product comprising computer program code means to make a computer execute a procedure for feedback cancellation, the computer program product comprising:
computer program code means for providing an adaptive feedback cancellation filter which adapts under the control of a control module; and
computer program code means for filtering at least one input of the control module to suppress correlated signals from the input prior to the control module operating upon the input.

The correlated signals to be suppressed may be selected to be those signals which are highly auto-correlated. The suppression of the correlated signals may comprise partial suppression, but preferably comprises substantially cancelling the correlated signals.

The control module preferably comprises a normalised least means squares (NLMS) control algorithm, or could comprise a least means squares (LMS) algorithm or other suitable algorithm. Both NLMS inputs, or both LMS inputs, are preferably decorrelated or whitened by suppression of the correlated signals.

In a preferred embodiment the feedback cancellation filter operates upon an un-whitened output signal to produce an un-whitened cancellation signal to be subtracted from an un-whitened input signal. In such embodiments an error signal input to the NLMS algorithm is preferably derived by:
providing an offline filter having an identical response to the feedback cancellation filter;
inputting to the offline filter a whitened output signal; and
subtracting an output of the offline filter from a whitened input signal to obtain the error signal.

Embodiments of the invention may further comprise partial notch suppression of a through signal in respect of which the feedback cancellation is applied. Such embodiments recognise that such suppression may be appropriate in a system where a NLMS algorithm is operating upon whitened signals. Such notch suppression is preferably applied by copying whitening filter settings into a notch suppression filter.

### BRIEF DESCRIPTION OF THE DRAWINGS

An example of the invention will now be described with reference to the accompanying drawings, in which:

FIG. 1 illustrates a generalised architecture for some embodiments of the present invention;

FIG. 2 illustrates one embodiment of the present invention in accordance with the architecture of FIG. 1;

FIG. 3 illustrates an optional additional feature to the architecture of FIG. 1 or FIG. 2;

FIG. 4 illustrates an embodiment of the invention in accordance with an alternative architecture;

FIG. 5 illustrates yet another embodiment of the invention in accordance with still another alternative architecture;

FIG. 6 illustrates an input sound signal which comprises tonal components;

FIG. 7 illustrates the frequency response of a whitening filter to the input sound signal shown in FIG. 6;

FIG. 8 illustrates an input spectrum to a feedback cancellation filter; and

FIG. 9 illustrates the feedback frequency response of the feedback cancellation filter.

### DESCRIPTION OF THE PREFERRED EMBODIMENTS

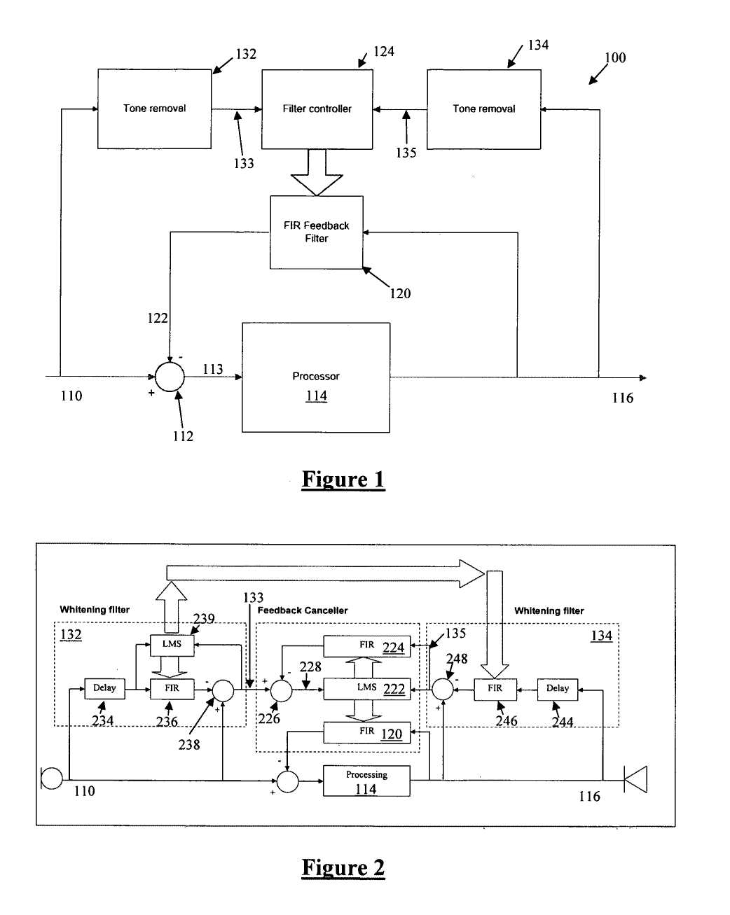

FIG. 1 illustrates a system 100 for sound signal processing. An input signal 110 derived from an input sound signal is passed to a summing node 112. A feedback cancellation filter 120 provides a level of cancellation of a feedback signal arising from feedback of the output signal 116 back to the system input. The feedback cancellation signal 122 produced by the feedback cancellation module 120 is subtracted from the input signal 110 to produce a feedback cancelled signal 113. Signal 113 is processed by a signal processor 114 implementing a processing algorithm, which could be any suitable hearing aid signal processing algorithm, one example of which being the ADRO technique set out in U.S. Pat. No. 6,731,767, the content of which is incorporated herein by reference.

Following processing by processor 114, the output signal 116 is output for conversion back to audio by a speaker and/or for further processing. The output signal 116 is also passed to the feedback cancellation filter 120. The filter 120 in this embodiment is a finite impulse response (FIR) filter with a filter response which approximates the response of the feedback path, and it filters the output signal 116 to produce feedback cancellation signal 122. The system 100 further includes a filter controller 124 which takes signals from the input 110 and output 116 and applies a normalised least means squares (NLMS) algorithm to derive appropriate new filter taps for the filter 120, and periodically updates the filter 120 with new filter taps.

To make the adaptive feedback cancellation resistant to entrainment from tones, the system 100 further includes tone removal blocks 132 and 134. The purpose of the tone removal blocks 132 and 134 is to use whitening filters to remove tones from both the input signal 110 and the output signal 116 before they enter the LMS stage 124 controlling the filter 120. Thus, tone removal block 132 produces a whitened input signal 133, and tone removal block 134 produces a whitened output signal 135.

FIG. 2 illustrates a system 200 which is one embodiment of the present invention in accordance with the architecture of FIG. 1. Reference numerals of FIG. 2 repeated from FIG. 1 refer to the same features as FIG. 1, and the description of each such feature is not repeated. The system 200 of FIG. 2 implements the tone removal blocks 132 and 134 as whitening filters. Tone removal block 132 comprises a delay block 234, which in this embodiment delays the input signal 110 by one sample. The delayed input signal is then passed to filter 236 which is designed to output a signal which when subtracted at 238 from the input signal 110 removes spectral peaks, or tones, from the input signal 110, to produce whitened input signal 133. Filter 236 is an adaptive FIR filter controlled by an NLMS algorithm in block 239. Providing the LMS algorithm with inputs comprising the whitened input signal 133 and the delayed input signal ensures that the LMS will function to control the FIR 236 to cancel correlated spectral peaks in the input signal.

The output whitening filter of tone removal block 134 operates in a directly analogous manner on the output signal 116, to such an extent that the filter taps derived by the LMS 239 are used not only for FIR 236 but also for FIR 246. Tone removal block 134 comprises a delay block 244, which in this embodiment delays the output signal 116 by one sample. The delayed output signal is then passed to filter 246 which, under the control of LMS 239 is designed to output a signal which when subtracted at 248 from the output signal 116 removes spectral peaks, or tones, from the output signal 116, to produce whitened output signal 135. Filter 246 is an adaptive FIR filter controlled by the NLMS algorithm in block 239.

In the system 200 of FIG. 2, the controller 124 shown in FIG. 1 is comprised of a LMS block 222, white domain FIR filter 224, and summing block 226. The FIR 224 is adaptive and uses identical taps to those used in the “un-whitened” domain by FIR 120. In contrast to the FIR 120, FIR 224 operates upon the whitened output signal 135, that is in the whitened domain. Thus, subtracting the output of FIR 224 from the whitened input signal gives the LMS 222 a whitened error signal 228. The LMS is thus never exposed to un-whitened tones in its inputs, and is therefore highly unlikely to become entrained by tonal signals whether musical tonal signals or feedback tones. Nevertheless, the whitened inputs to LMS 222 carry much of the spectral information required for the LMS 222 and FIR 120 to accurately model the feedback path and to produce an effective feedback cancellation signal 122.

The LMS algorithm 222 of the controller 124 essentially looks for correlation between the two input signals 228 and 135. A simplistic assumption might be that correlation between the two signals only arises due to a feedback path, however the present invention recognises that a tonal signal such as music will also cause correlation. Therefore, removing the tones from both the input signal 110 and from the output signal 116 before they reach the LMS algorithm means that the LMS algorithm will only train to the feedback path. Because an identical whitening filter is applied to both inputs of the LMS algorithm, the FIR will model the feedback path accurately. This allows the same FIR taps to be used for the cancellation of the true signal path. Notably, tone removal 132 and 134 will remove tones from the signals 110 and 116 irrespective of whether the tones arise from tonal signals such as music or from feedback. Such tone removal nevertheless passes much of the spectrum to the filter controller 124 enabling it to model the feedback path with sufficient accuracy that filter 120 will provide adequate feedback cancellation.

Advantageously, the architecture of FIGS. 1 and 2 allows the filter 120 to continue to be updated at a high adaptation rate even in the presence of tonal input signals such as music. Consequently, the filter 120 does not need to enter a special slowed or frozen state in the presence of music or tones. Because the filter 120 adapts at the normal adaptation rate, it remains capable of avoiding feedback under fast changing feedback conditions, even in the presence of tonal input signals. A further advantage of the architecture of FIG. 1 is that there is no requirement to differentiate between tonal signals such as music on the one hand and feedback squeals on the other hand, which is normally a difficult task. While tone removal blocks 132 and 134 will remove any feedback squeal from the signals processed by the controller 124, this will not prevent feedback cancellation as the NLMS algorithm 222 of the controller 124 will still adapt in response to non-tonal sounds close in frequency to the squeal.

Notably, in this embodiment the number of taps of the whitening filters 236 and 246 is the same as the number of taps of FBC filter 120. This ensures that all filters have the same frequency resolution. If the whitening filters 236, 246 were to have poorer resolution (fewer taps) than the FBC filter 120, they might remove overly large frequency ranges when a tone is present, which the feedback canceller and LMS 222 would then be forced to ignore when modelling the feedback path. It is noted that more taps could be used in the whitening filters 236, 246 than in the FBC filter 120.

To ensure correct adaption of the FBC filters 120 and 224, it is important that the whitening filters 236 and 246 have the same tap values. This guarantees that the Feedback Canceller will accurately track the true response of the feedback path. A complicating factor in synchronising the filters is that a signal will typically pass through FIR 246 earlier than it passes through FIR 236. This is due to the extra delay through receiver 116, the feedback path and the microphone 110. Setting the bulk delay 244 to be as large as possible will help to keep the signal path differences to a minimum. In addition, updating the whitening FIRs 236 and 244 only at regular intervals (for example, once every 128 samples) will ensure that there is only a small difference in the two signal paths for a very brief period of time after the update.

It is noted that due to the removal of spectral peaks by the whitening filters 132 and 134, the system 200 could be slightly more susceptible to feedback in the regions where tones are present. To combat this, an additional partial whitening filter can be added to the system if deemed necessary, as shown in FIG. 3. This optional section 310 involves “partially whitening” the signal path. By putting a shallow notch in the frequency response of the forward path that aligns exactly with the deep notches in the whitening filter the chances of feedback occurring at the same frequency as a tone is greatly reduced. FIG. 3 shows an efficient architecture for achieving this. Once again, the signal is delayed at 312 by one sample, and the FIR 314 is adaptive under the control of the LMS 239 of FIG. 2, ensuring that the spectral response of FIR 314 has notches in identical locations as the spectrum which is input to the LMS 222. The notch depth imposed by filter 310 is limited to 6 dB by gain block 316, which ensures that only half of the signal output by the FIR 314 is ever subtracted from the feedback cancelled signal output by summing node 112. In light of the substantially larger dynamic range of the human ear even for impaired hearing persons, this 6 dB notch suppression has only a small effect on the sound quality of the tones to which the filter is responding, but is enough to reduce the susceptibility of the system to feedback. It will be appreciated that the notch depth can be easily adapted to an appropriate level by appropriate control of the gain block 316. For example the gain block 316 could be set to a value anywhere between 0 (to disable the partial whitening filter 310 entirely) and 1 (to provide complete notch suppression). For example the gain value 316 could be adaptive in response to environmental conditions, user preference, device settings and/or feedback conditions. The gain block 316 could also incorporate a high pass filter component to ensure that gain reductions are only applied in the relatively high frequency regions where feedback is likely to occur. This could help with maintaining speech quality, as the spectral content of speech in the low frequencies could otherwise cause its amplitude to be reduced by the “partial whitening”.

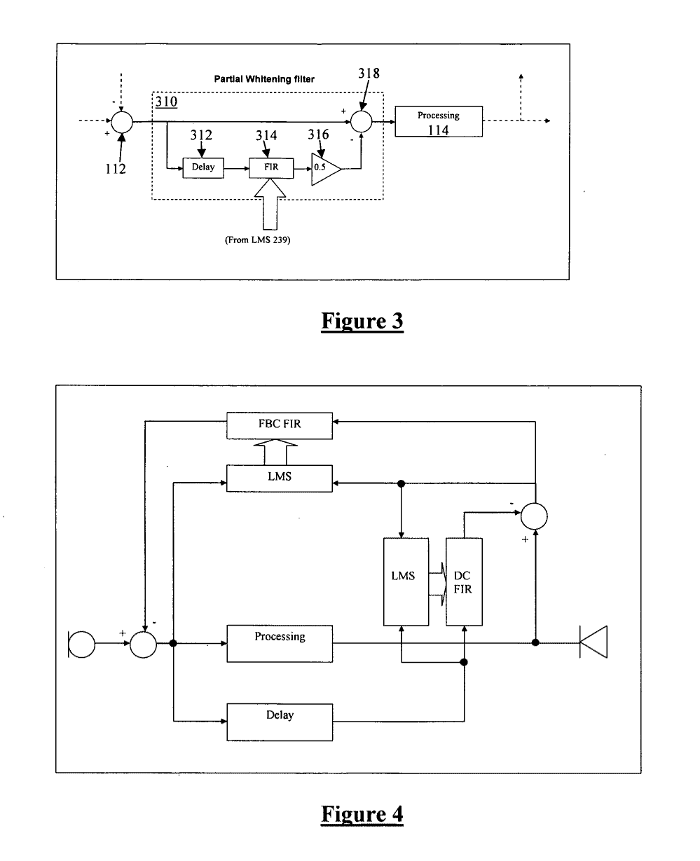

FIG. 4 illustrates an embodiment of the invention in accordance with an alternative architecture. This architecture removes correlation from the output signal before it is fed to the FBC. There are a number of different variants which may be made to the architecture of FIG. 4, for example the input signal for the delay block could alternatively be taken from before the summing node or from after the processing block. Taking the FBC FIR input from the output signal rather than from the “decorrelation filter” (DC FIR) has the advantage of allowing the LMS algorithm controlling the FBC FIR to learn from a clean whitened signal as produced by the DC FIR, while still using the complete output signal as an input to the FBC FIR to generate the feedback cancellation signal to be subtracted from the input. This is important as a tonal input still needs to have its feedback component cancelled. In the alternative where the output of the processing block is input to the delay block and then to the DC FIR, there are the advantages of requiring a smaller delay (the processing block having added some delay), having the signal being slightly whitened by the processing strategy, and having similar input levels into the LMS algorithm causing less tap scaling issues.

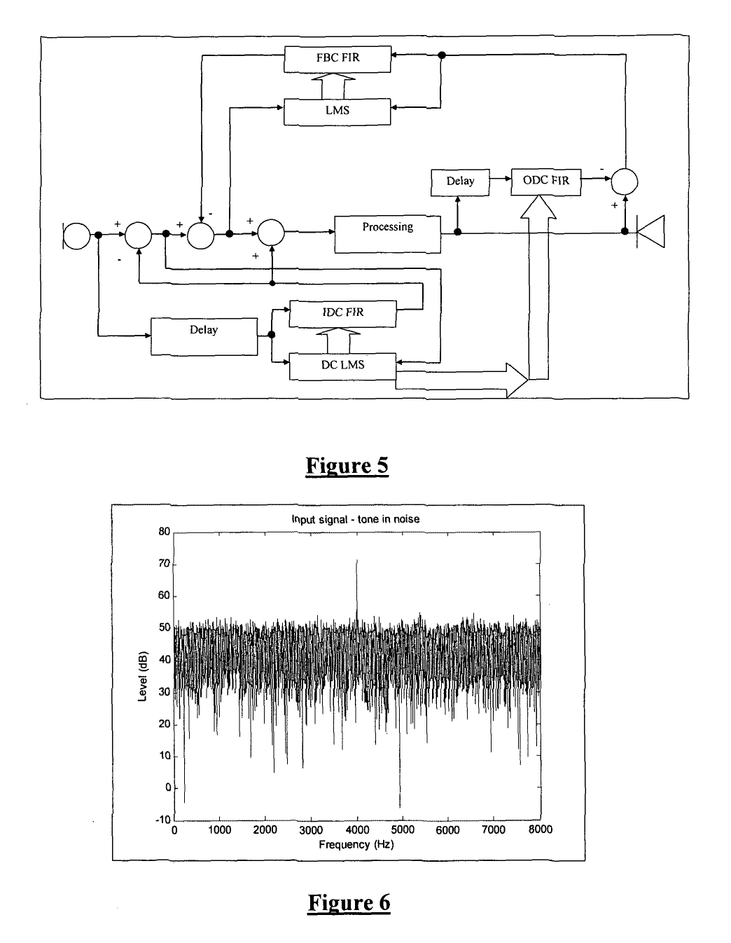

FIG. 5 illustrates another embodiment of the invention in accordance with a further alternative architecture. The architecture of FIG. 5 provides for the input signal decorrelation filter (IDC FIR) to remove correlation from the input signal before it is fed to the LMS block of the FBC FIR. Further, the tonal components of the output signal are removed by the output decorrelation filter ODC FIR directly at the input before the FBC FIR. Tonal components from the IDC FIR are then added back in after the FBC FIR has cancelled any feedback signals, before the processing block.

An alternative architecture to FIG. 5 would be for the FBC FIR profile to be used both to cancel the decorrelated signal, to be fed back to the FBC LMS, and to cancel the normal input signal, to be fed to the processing block. This option is functionally equivalent to that shown in FIG. 5.

An advantage of decorrelating or whitening the input signal is that this is the signal in which the tone will be most dominant because there has been no processing to flatten the response. Also there is a risk that if the tone is reduced in the output signal, then it will in fact be boosted by the FBC FIR in order to cancel the tone in the input signal.

As shown in FIG. 5, the filter taps derived for the IDC FIR for cancelling the tone in the input signal can also be used for the ODC FIR to cancel the tone in the output signal. This has the advantage of whitening both signals and should therefore give a better estimate of the feedback path.

The presently described embodiments thus aim to ensure that the FBC filter taps never become corrupted, by removing tonal and highly auto-correlated signals before they reach the FBC adaptive processing. It is noted that alternative embodiments may use a delay block which delays the signal by an amount that is larger than the possible feedback path delay. Such a delayed signal will then be completely uncorrelated with the normal input and output signals, unless a tonal or highly auto-correlated signal is present. In this situation where there is a correlated signal present, an adaptive filter can be used to remove the correlation from the input and/or output signal. The “cleaned” signals will then only contain correlation due to the feedback path and can be used to train a FBC without the risk of it becoming entrained. It may also be possible to look for correlation between the delayed signal and the FBC filter taps to detect and remove entrainment, but it is more desirable to prevent entrainment in the first place.

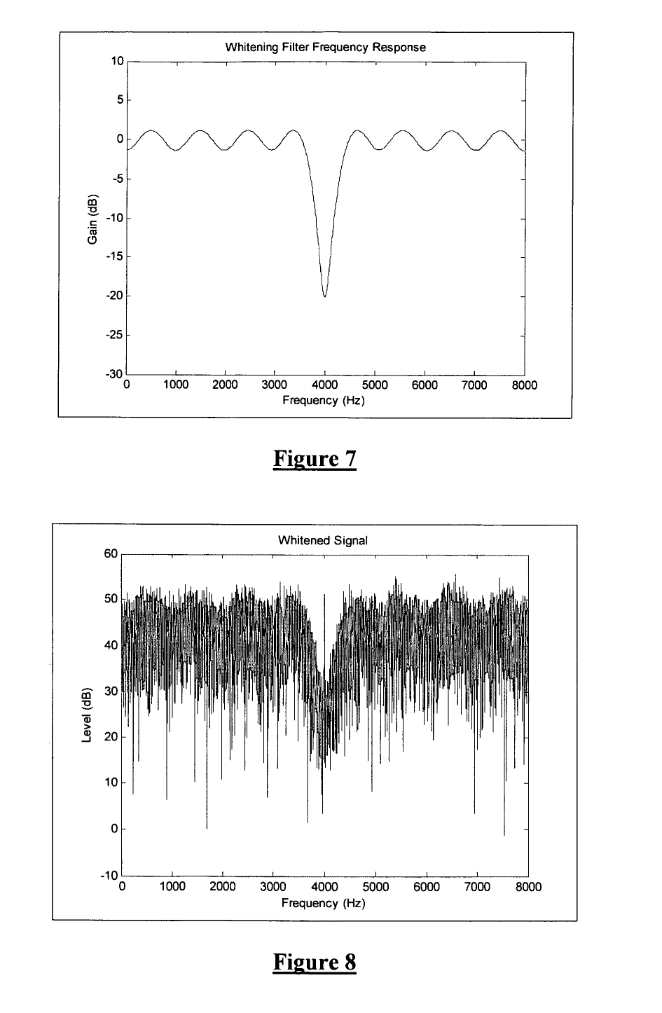

The device for feedback cancellation in the presently described embodiments use whitening filters to suppress tonal components before the signal reaches the feedback cancellation algorithm. This prevents tonal components from causing entrainment of the feedback cancellation. As is illustrated with reference to FIGS. 6 to 9, the effectiveness of the device is assured by the feedback cancellation filter having the same number of taps as the whitening filters. In this regard, when a device receives an input signal having tonal components, as illustrated in FIG. 6, then the whitening filters takes on the response shown in FIG. 7 and the resultant spectrum which is fed to the feedback cancellation filter is as shown in FIG. 8.

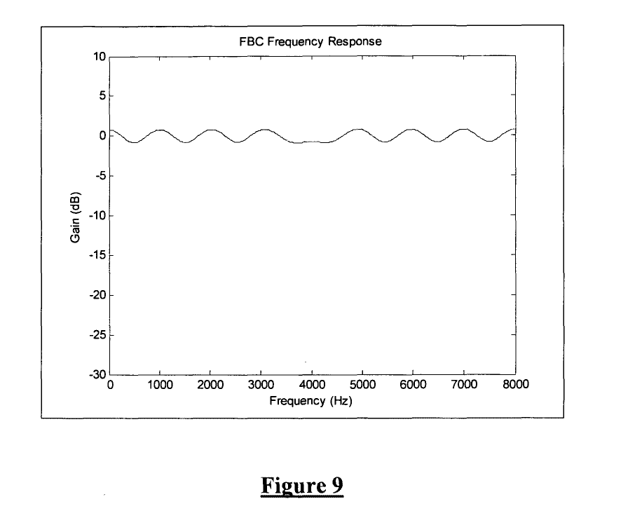

As will be appreciated from the foregoing discussion, if the nominal notch width of a whitening filter is given by Fₙ then two sections of the spectrum are effectively missing, each of which is Fₙ/2 wide. Since the feedback cancellation filter has the same frequency resolution as each of the whitening filters, the sections of missing spectrum will be narrower than its nominal resolution. The feedback cancellation filter will therefore interpolate across the missing sections of spectrum as shown in FIG. 9.

With particular regard to hearing aids, the feedback path typically does not have large discontinuities in its frequency response so the interpolation will give a very good estimate of the actual feedback path.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A method for feedback cancellation, the method comprising:
providing an adaptive feedback cancellation filter which adapts under the control of a control module; and
filtering at least one input of the control module to suppress correlated signals from the input prior to the control module operating upon the input.

2. The method of claim 1, further comprising selecting the correlated signals to be suppressed to be those signals which are highly auto-correlated.

3. The method of claim 2, further comprising partially suppressing the correlated signals.

4. The method of claim 2, further comprising substantially cancelling the correlated signals.

5. The method of claim 1, further comprising the adaptive feedback cancellation filter operating upon an un-whitened output signal to produce an un-whitened cancellation signal to be subtracted from an un-whitened input signal.

6. The method of claim 5, wherein an error signal input to the control module is derived by:
providing an offline filter having an identical response to the feedback cancellation filter;
inputting to the offline filter a whitened output signal; and
subtracting an output of the offline filter from a whitened input signal to obtain the error signal.

7. The method of claim 1, further comprising partial notch suppression of a through signal in respect of which the feedback cancellation is applied.

8. The method of claim 7, wherein notch suppression is applied by copying whitening filter settings into a notch suppression filter.

9. A device for feedback cancellation, the device comprising:
an adaptive feedback cancellation filter;
a control module which controls adaptation of the adaptive feedback cancellation filter; and
at least one filter for suppressing correlated signals from an input to the control module prior to the control module operating upon the input.

10. The device of claim 9, wherein the control module comprises one of a normalised least means squares (NLMS) control algorithm and a least means squares (LMS) algorithm.

11. The device of claim 10, wherein inputs to the NLMS control algorithm or inputs to the LMS control algorithm are decorrelated or whitened by suppression of the correlated signals.

12. The device of claim 9, wherein the adaptive feedback cancellation filter operates upon an un-whitened output signal to produce an un-whitened cancellation signal to be subtracted from an un-whitened input signal.

13. The device of claim 12, wherein an error signal input to the NLMS algorithm is derived by:
providing an offline filter having an identical response to the feedback cancellation filter;
inputting to the offline filter a whitened output signal; and
subtracting an output of the offline filter from a whitened input signal to obtain the error signal.

14. The device of claim 9, further comprising a notch suppression filter for partial notch suppression of a through signal in respect of which the feedback cancellation is applied.

15. A computer program product comprising computer program code means to make a computer execute a procedure for feedback cancellation, the computer program product comprising:
computer program code means for providing an adaptive feedback cancellation filter which adapts under the control of a control module; and computer program code means for filtering at least one input of the control module to suppress correlated signals from the input prior to the control module operating upon the input.
